(19) United States
(12) Patent Application Publication
(10) Pub. No.: US 2009/0266361 A1
(43) Pub. Date: Oct. 29, 2009

(54) Respiratory breathing devices, methods and systems

(76) Inventors: Adam S. Bilger, Butler, PA (US); Roger P. Wolf, Butler, PA (US); Thomas L. Panian, Allison Park, PA (US); Martin S. Catanzarite, Pittsburgh, PA (US)

Correspondence Address: MINE SAFETY APPLIANCES COMPANY, P.O. BOX 426, PITTSBURGH, PA, 15230, US

(21) Appl. No.: 12/150,538

(22) Filed: Apr. 29, 2008

(51) Int. Cl. A62B 7/00

(52) U.S. Cl. 128/204.21

(57) ABSTRACT

A powered air purifying respirator system for use with at least one filter system includes: a housing including at least one inlet port and at least one outlet port; a motorized air flow system to draw air into the housing via the at least one inlet port; a control system in communicative connection with the motorized air flow system; and a filter system sensor in communicative connection with the control system. The filter system sensor provides information to the control system relating to the type of the at least one filter system upon fluid connection thereof with the housing. The control system can control the motorized air flow system at least in part on the basis of the type of filter system sensed by the filter system sensor. Another powered air purifying respirator system for use with at least one filter system includes: a housing including at least one inlet port and at least one outlet port; a motorized air flow system to draw air into the housing via the at least one inlet port; a control system in communicative connection with the motorized air flow system; and a pressure sensor in communicative connection with the control system to provide information to the control system relating to ambient pressure. The control system can, for example, control the motorized air flow system at least in part on the basis of the information relating to ambient pressure.

### BACKGROUND OF THE INVENTION

The present invention relates to respiratory breathing devices, systems and methods and, particularly to Powered Air-Purifying Respiratory breathing devices, systems and methods.

The following information is provided to assist the reader to understand the invention disclosed below and the environment in which it will typically be used. The terms used herein are not intended to be limited to any particular narrow interpretation unless clearly stated otherwise in this document. References set forth herein may facilitate understanding of the present invention or the background of the present invention. The disclosure of all references cited herein are incorporated by reference.

There are a number of respiratory breathing systems commercially available to protect people from a variety of respiratory hazards. One type of respiratory breathing system, commonly referred to as Powered Air-Purifying Respirator systems or PAPR systems, uses a powered (typically battery powered) motor to drive a blower to deliver air to the user of the system. PAPR systems are used for protection from a variety of hazardous agents including gases, vapors and/or particulates.

Typically PAPR systems include a number of interchangeable components that enable the PAPR system to meet the demands of a variety of applications and/or environments. The powered air delivery system of a PAPR system can, for example, be placed in fluid connection with a variety of components to be worn by the user, which can, for example, include a facepiece, a hood or shielded helmet (sometimes referred to herein individually and collectively as “respirator inlet coverings” or RIC). In addition to the power supply/battery, motor and blower, the air delivery system can include a number of different air delivery hoses, hose attachments and filter systems. The filter systems can, for example, include one or more different filter cartridges. Each filter cartridge typically includes a housing and one or more types of filtering media therein for removal of one or more specific agents.

The motor and blower of the air delivery system must be able to provide suitable air flow through the respiratory system regardless of the PAPR configuration. The air flow delivery requirements of the PAPR change as a result of changes in the system configuration. In that regard, each component has an associated pressure drop or resistance and the cumulative pressure drop or resistance across a PAPR system changes as the system components are changed, altering the flow delivery capacity of the motor and blower. Moreover, changes within the PAPR system as a result of operation over time can also cause changes in air delivery requirements of a PAPR system. For example, filter loading, blockage, component wear, frictional increases, and battery power loss can individually and collectively cause changes in air delivery requirements. The air delivery rate of the motor and blower can be adjustable to adapt to such system variation.

PAPRs are typically equipped with manually operated or automated control systems to assist in maintaining and/or adjusting the air delivery rate. Control systems can, for example, incorporate feedback response to maintain operation in a predetermined range. A control set point or range for a feedback variable can be established by directly measuring air flow or by measurement of a related variable such as motor current or motor speed. A calibration protocol can be used to establish such a set point or range for a particular PAPR configuration. An initial calibration of the PAPR system can be made upon the PAPR system being placed in service. Also, periodic recalibration of the system can be made over the operational life of the system.

Moreover, to assist in establishing air delivery operational requirements for a specific PAPR configuration, Published PCT International Patent Application No. 2005/087319 discloses the use of a switch to detect the type of delivery hose/respiratory inlet covering connected to the outlet port of the PAPR device thereof. The detecting switch is integrated into the outlet port of the PAPR device and communicates the detected configuration to an electronic control. Depending on the detected configuration (corresponding to differing designs of hose fittings of a connected breathing hood or mask and/or of differing designs of breathing hoods or masks) different operating modes can be effected by the electronic control system.

Although a number of calibration and control systems and methods are used in connection with PAPR systems, a number of problems are associated with currently available PAPR systems and the methods of operation thereof. For example, calibration may require at least partial disassembly of the PAPR system, which can be cumbersome and time consuming, particularly while in the field. Moreover, many calibration and control systems and methods can consume significant power, resulting in reduced battery life. For example, PAPR systems are often calibrated and controlled to provide sufficient air flow for the configuration providing the highest resistance to flow, resulting in air flow rates higher than desirable, excess power consumption and excess motor wear in connection with configurations with lower resistance. Further, currently available PAPR systems do not adequately address change in operation of the system as a result of ambient pressure change (for example, as a result of altitude changes).

It thus remains desirable to develop improved devices, systems and methods which reduce or eliminate the above-identified and/or other problems associated with currently available PAPR systems.

### SUMMARY OF THE INVENTION

In one aspect, the present invention provides a powered air purifying respirator system for use with at least one filter system including: a housing including at least one inlet port and at least one outlet port; a motorized air flow system to draw air into the housing via the at least one inlet port; a control system in communicative connection with the motorized air flow system; and a filter system sensor in communicative connection with the control system. The filter system sensor provides information to the control system relating to the type of the at least one filter system upon fluid connection thereof with the housing. The control system can control the motorized air flow system at least in part on the basis of the type of filter system sensed by the filter system sensor.

The filter system can, for example, include a filter cartridge which includes at least one filtering medium positioned within a filter cartridge housing.

The powered air purifying respirator system can further include a pressure sensor to measure ambient pressure. The control system can, for example, control the motorized air flow system at least in part on the basis of information relating to ambient pressure.

The powered air purifying respirator system can also include at least one configuration sensor to sense the type of respiratory inlet covering in fluid connection with a delivery hose upon fluid connection of the delivery hose with the outlet port.

In several embodiments, the control system determines a set point for the rate of rotation of a motor of the motorized air flow system. Limits above and below the set point can, for example, be established and an alarm system can actuated if the motor rate is outside one of the limits for a determined period of time. The limits can, for example, be adjusted by the same amount as the set point as a result of at least one of the following: the type of filter system, the measured ambient pressure or the type of respiratory inlet covering.

The powered air purifying respirator system can further include a system to measure battery voltage. The control system can determine the set point at least in part on the basis of the measured battery voltage.

The powered air purifying respirator system can further include the at least one filter system.

In another aspect, the present invention provides a powered air purifying respirator system for use with at least one filter system including: a housing including at least one inlet port and at least one outlet port; a motorized air flow system to draw air into the housing via the at least one inlet port; a control system in communicative connection with the motorized air flow system; and a pressure sensor in communicative connection with the control system to provide information to the control system relating to ambient pressure. The control system can, for example, control the motorized air flow system at least in part on the basis of the information relating to ambient pressure.

In a further aspect, the present invention provides a method of operating a powered air purifying respirator system, including: sensing a filter system placed in operative connection with the powered air purifying system and controlling the powered air purifying respirator system at least in part on the basis of information relating to the filter system. The method can further include determining a set point for the rate of rotation of a motor of the motorized air flow system at least in part on the basis of the information relating to the filter system. The method can also include determining limits above and below the set point and activating an alarm system if the rate of rotation of the motor is outside one of the limits for a determined period of time. In several embodiments, the method also includes measuring ambient pressure and controlling the powered air purifying respirator system at least in part on the basis of information relating to ambient pressure.

The present invention provides significant advantages over currently available powered air purifying systems by, for example, controlling the motorized blower thereof on the basis of a determined resistance to flow of a sensed PAPR configuration, including determination of the type of filter system(s) incorporated into the PAPR system. Sufficient air flow is provided without substantial risk of excessive air flow rates which are associated with user discomfort, excessive battery consumption and excessive component (including, for example, motor) wear. Moreover, the PAPR devices, systems and methods of the present invention are the first to control operation at least in part on the basis of information related to measured ambient pressure.

The present invention, along with the attributes and attendant advantages thereof, will best be appreciated and understood in view of the following detailed description taken in conjunction with the accompanying drawings.

### BRIEF DESCRIPTION OF THE DRAWINGS

FIG. 1 illustrates a front view of an embodiment of an air delivery or PAPR system of the present invention with two different respiratory inlet coverings.

FIG. 2 illustrates the air delivery system of FIG. 1 wherein the delivery hose and battery pack are disconnected from the housing.

FIG. 3 illustrates an exploded perspective view of the blower assembly of the air delivery system of FIG. 1A.

FIG. 4 illustrates a front view of the blower assembly with the filter cartridges removed therefrom.

FIG. 5 illustrates an alternative embodiment of a blower assembly inlet operable to receive and sense multiple filter systems such as filter cartridges in series.

FIG. 6 illustrates another rear view of the blower assembly wherein a rear panel of the housing thereof has been removed.

FIG. 7 illustrates a side, partially cross sectional view of the blower unit.

FIG. 8 illustrates a block diagram of the blower assembly and communications paths therein.

FIG. 9 illustrates an embodiment of a flow chart of software control procedure of the present invention.

FIG. 10A illustrates another flow chart of software control of the present invention.

FIG. 10B illustrates a continuation of the flow chart of FIG. 10A.

### DETAILED DESCRIPTION OF THE INVENTION

As used herein and in the appended claims, the singular forms “a,” “an”, and “the” include plural references unless the content clearly dictates otherwise. Thus, for example, reference to “a sensor” includes a plurality of such sensors and equivalents thereof known to those skilled in the art, and so forth, and reference to “the sensor” is a reference to one or more such sensor and equivalents thereof known to those skilled in the art, and so forth.

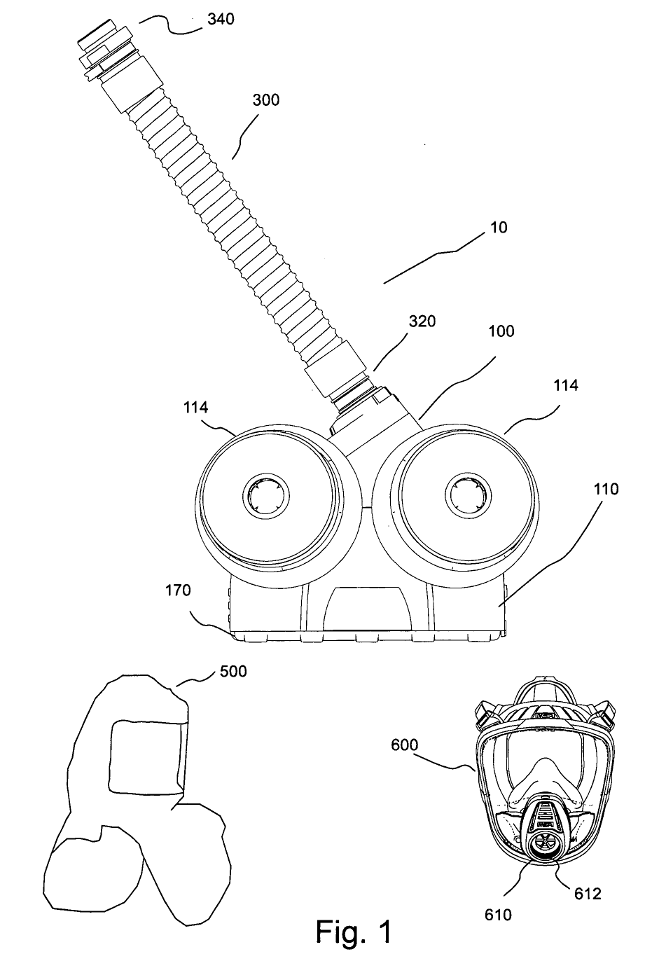

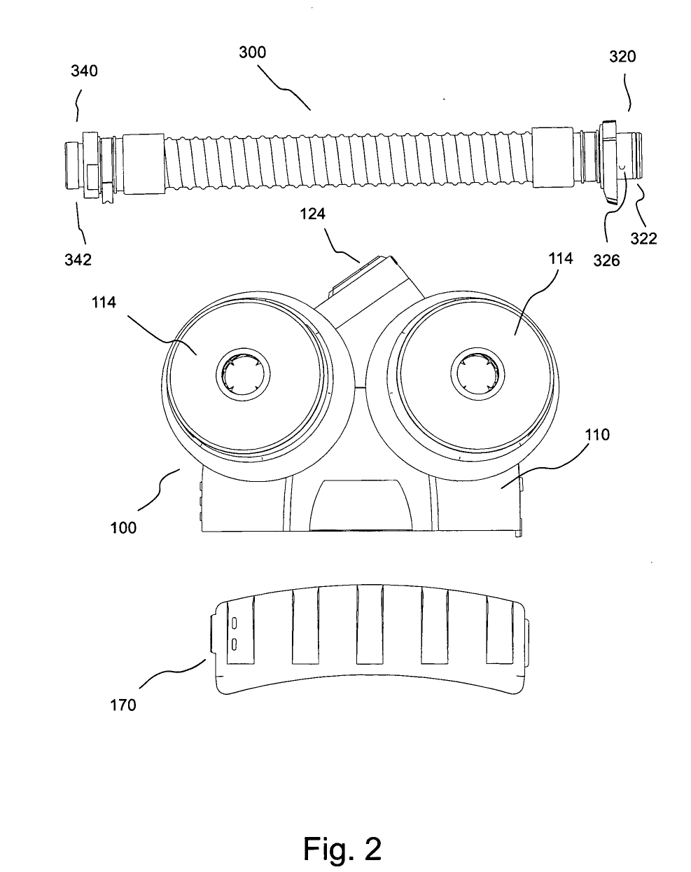

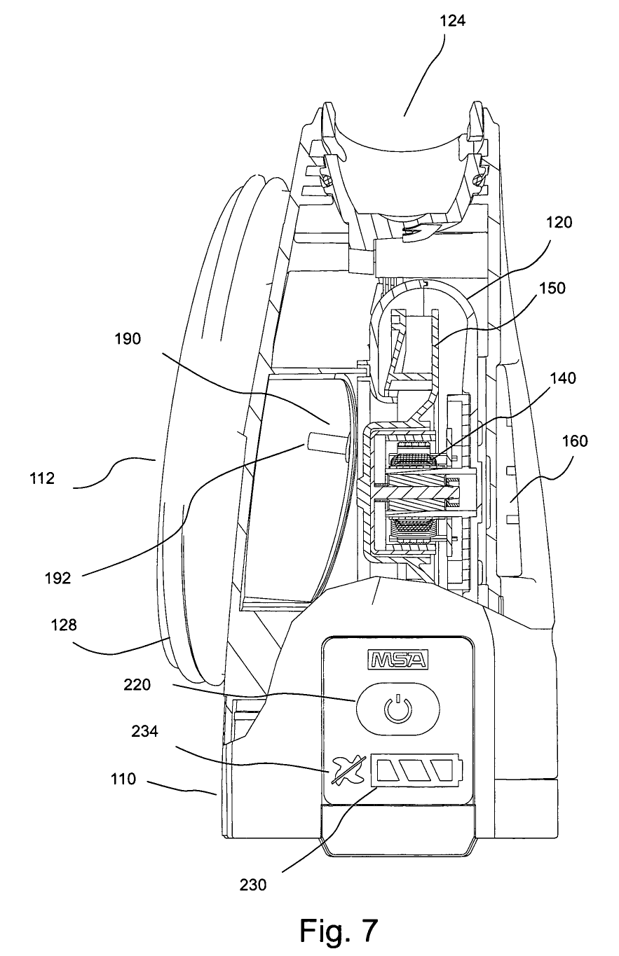

FIGS. 1 through 10B illustrate an embodiment of an air delivery or PAPR system 10 of the present invention. Air delivery system 10 includes blower assembly 100 in fluid connection with a delivery tube or hose 300. As illustrated, for example, in FIG. 2, delivery hose 300 includes a first connector 320 for connection to an outlet 124 of a scroll housing 120 (see FIG. 6) of blower assembly 100 and a second connector 340 for connection to a user worn component or respiratory inlet covering such as a hood 500 or a mask 600 (see FIG. 1).

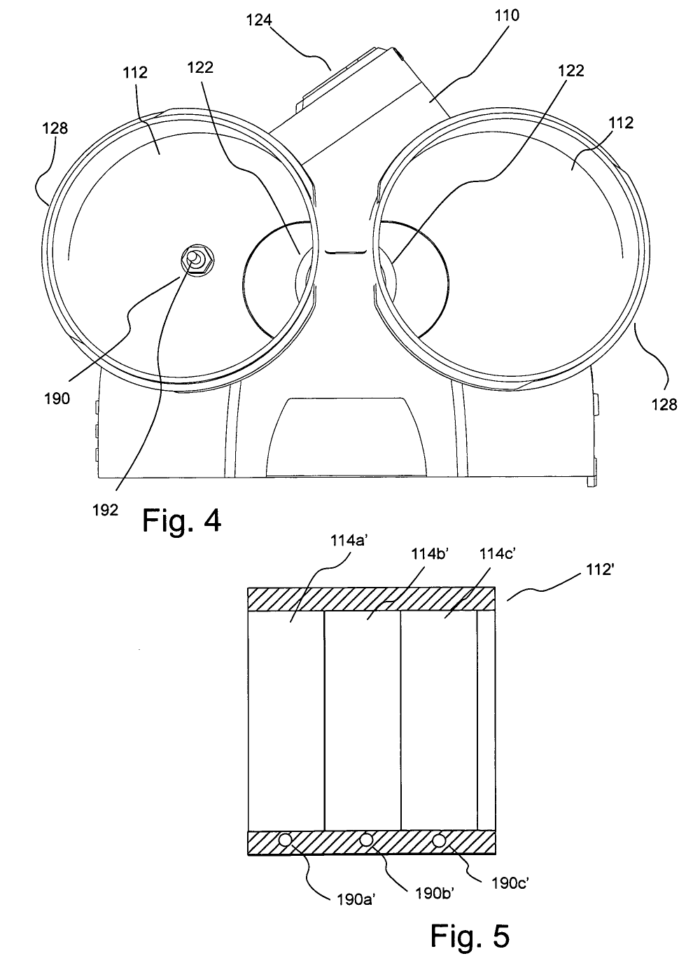

Blower assembly 100 includes a housing 110 and a scroll housing 120 which can, for example, be fabricated from a polymeric material such as TERBLEND® (ABS/nylon blend), available from BASF Corporation of Florham Park, N.J. Air from the surrounding environment is drawn into housing 110 via a motor driven impeller 150 positioned within scroll housing 120 via inlet port or openings 112 which are in fluid connection with inlet ports or openings 122 of scroll housing 120 (see, for example, FIG. 4). During operation, filter cartridges 114 are placed in connection with openings 112 so that the air from the surrounding environment is forced/drawn through filter cartridges 114. The user of the PAPR thus breathes ambient air after the air has passed through filter cartridges 114 for purification. As clear to those skilled in the art, filter systems such as filter cartridges 114 can be placed downstream from motor driven impeller 150 (for example, in fluid connection with or in the vicinity of outlet 124) such that air drawn into scroll housing 120 is forced/pushed through filters cartridges 114 for purification and subsequent delivery to the user.

As known in the art, the cartridges can, for example, include a mechanical filter to trap airborne particles and/or a sorbent system suitable to adsorb various gases and/or vapors. Typically, filter cartridges are approved for specific gases and/or vapors as described in associated documentation provided by the manufacturer thereof. Filter cartridges 114 can, for example, be attached to inlet ports 112 via threading 128 formed on the exterior surface of inlet ports 112.

Blower assembly 100 thus assists breathing by forcing (that is, pushing or pulling) air through cartridges 114 and delivering the purified air through air delivery tube or hose 300 to, for example, an inlet (not shown) of hood 500, an inlet 610 of facepiece 600 or an inlet of another respiratory inlet covering. In that regard, an electric motor 140 drives impeller or blower 150, which are positioned within scroll housing 120. As described above, rotation of impeller 150 within scroll housing 120 forces ambient air through cartridges 114. Purified air exits scroll housing 120 via an outlet 124 and enters delivery hose 300.

Connector 320 on delivery hose 300 can, for example, include one or more connecting elements or members 322 (for example, flanges and/or slots) which cooperate with one more retaining elements or member 126 (for example, flanges and/or slots) of outlet 124 to form a generally air-tight connection. For example, a bayonet connection as known in the connector arts can be formed. Connector 340 can, for example, include threading 342 which cooperates with, for example, threading 612 formed on an interior surface of respiratory inlet 610 of facepiece 600 or the respiratory inlet of another respiratory inlet covering.

Blower assembly 100 can, for example, be attached to the user via a belt (not shown) which passes through openings 160 formed in a rear surface of housing 110.

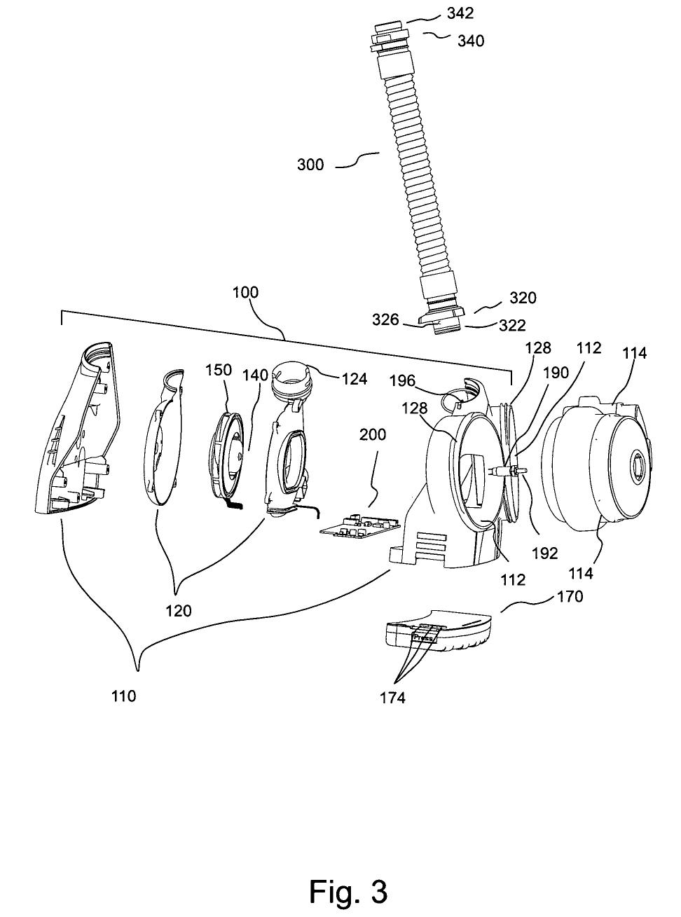

In the illustrated embodiment, a rechargeable battery pack 170 (for example, a “standard” 12 volt (nominal) nickel-metal hydride (NiMH) battery pack or an “extended use” 14.4 volt (nominal) lithium ion (Li-Ion) battery pack) is inserted onto the bottom of blower assembly housing 110 so that contacts (not shown) of battery pack 170 form an electrical connection with electrical contacts 174 (see, for example, FIG. 3).

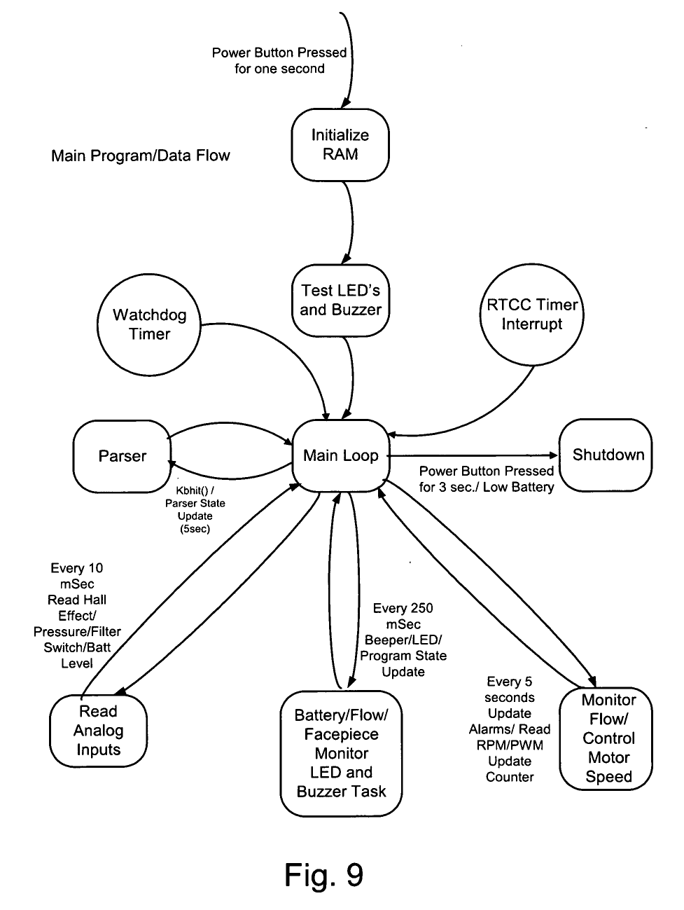

FIG. 8 illustrates a schematic representation or block diagram of the components and electrical signals/transmissions of blower assembly 100. In the illustrated embodiment a control system 180 includes, for example, a processor 182 (for example, a microprocessor) and a memory 184. Control system 180 is in communicative connection with at least one filter system sensor 190 which can, for example, operate to sense what type of filter system (for example, filter cartridge 114) is placed in operative connection with blower housing 110. In the illustrated embodiment, a single filter system sensor 190 is positioned within one of inlet ports 112 as illustrated, for example, in FIG. 4. Identical filter cartridges 114 are used in connection with air delivery system 100 to provide the same purification properties for each inlet port 112. Many different types of sensors can be used to sense the type of filter cartridge (or other filter system) placed in connection with blower assembly housing 110. For example, one or more optical, mechanical, electromagnetic, electromechanical or other sensors as known in the sensor arts can be used. Such sensor(s) can be placed at many different positions within inlet ports 112.

In several embodiments, filter system sensor 190 includes a mechanical switch mechanism to distinguish between attached filter cartridges 114 based upon the distance the back surface of an attached filter cartridge 114 extends rearward within inlet port 112. In one embodiment, a first type of filter cartridge 114 (for example, a chemical filter) extends rearward a sufficient amount to contact a switch element 192 of sensor 190, while a second type of filter 114 (for example, a particulate filter) does not extend rearward a sufficient amount to contact switch element 192. Thus, actuation of switch element 192 is indicative of the presence of the first type of filter cartridge 114, while no actuation of switch element 192 is indicative of the presence of the second type of filter cartridge 114. A plurality of sensors 190 having switch elements 192 that extend to different positions can be used to detect more than two types of cartridges. Further, the distance a switch or contact element is caused to be moved rearward by contact with a filter cartridge can be measured. In any event, control system 180 receives a signal from sensor 190 to determine a particular type of filter cartridge 114 (for example, via a lookup table or formula stored within memory 182).

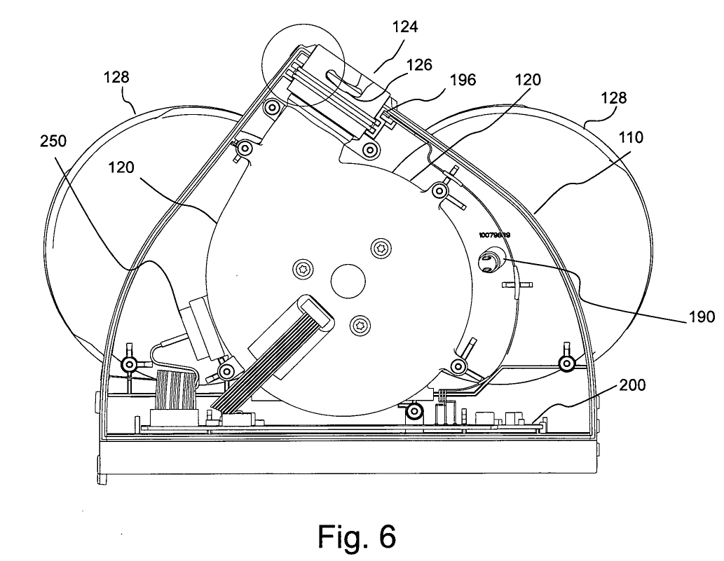

As illustrated in FIG. 5, another embodiment of an inlet port 112′ can be adapted to receive and retain (for example, via cooperating threading, bayonet connections, and/or other connection systems as know in the art) multiple filter systems such as filter cartridges 114a′, 114b′ and 114c′ such that air passes through each filter cartridge 114a′, 114b′ and 114c′ in series and the purifying effect of each is additive. Inlet port 112′ can, for example, include multiple sensors 190a′, 190b′ and 190c′ to enable identification of each of filter cartridges 114a′, 114b′ and 114c′ and appropriate control of blower assembly 100.

At least one other sensor 196 (see FIGS. 3 and 8) can be positioned within or in the vicinity of outlet 124 to be in the vicinity of an attached connector 320 to sense the configuration of the hose 300 and the connected respiratory inlet covering (for example, hood 500 or facepiece 600). Like sensor(s) 190, sensor(s) 196 can be generally any type of sensor suitable to sense the configuration of hose 300 and the connected respiratory inlet covering. Sensor 196 can, for example, be in the form of a ratiometric Hall Effect sensor/circuit to sense the polarity of a magnet 326 (see FIGS. 2, 3 and 8) positioned on or within connector 320 of delivery hose 300. Depending on the presence/absence of magnet 326 and/or its polarity, the configuration of hose 300 and the connected respiratory inlet covering is sensed and certain operating points are selected.

Signals from sensors 190 and 196 to control system 180 are used to generally fully identify the configuration of PAPR systems 10 of the present invention. Many different system configuration can be sensed. For example, in one embodiment, four different configurations could be sensed as follows: (1) hood and a first type of filter cartridge (for example, a particulate filter); (2) hood and second type of filter cartridge (for example, a chemical filter); (3) facepiece and the first type of filter cartridge; and (4) facepiece and the second type of filter cartridge. One skilled in the art appreciates that more than four configurations can be readily sensed.

Once the system configuration is determined as described above, this configuration can, for example, be associated with a corresponding pressure drop across the system and a corresponding motor speed (for example, in revolutions per minute) required to achieve a desirable flow rate of air through the system. Motor speeds setting for each system configuration can, for example, be determined experimentally.

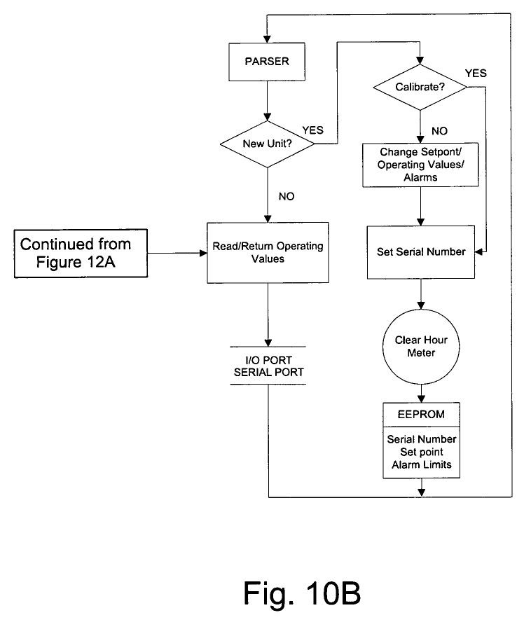

In one embodiment, motor 140 was a brushless DC (BLDC). Processor 182 was a PIC16F876A microprocessor available from Microchip Technology Inc. of Chandler, Ariz. mounted on a printed circuit board 200. Processor 182 was in communicative connection with a motor controller 210, which was an L6235 PWM motor control microchip available from ST Microelectronics of Geneva, Switzerland. Processor 182 executed software stored in associated memory 184 to effect control of system 10. FIGS. 11 through 12B illustrate flow charts for one embodiment of software control of system 10. The software was downloaded to printed circuit board 200 via an input/output port in the form of a 5-pin debugging/serial programming port (see, for example, FIG. 10B).

PWM motor control microchip or controller 210 was a constant current PWM controller which supplied all the drive signals and feedback for three-phase brushless DC motor (BLDC) 140 in blower assembly 100. Controller 210 also provides a feedback signal to processor 182 to indicate motor speed in the form of a pulse train. The frequency of the pulse train corresponds to the motor rate in, for example, revolutions per minute or RPM. Processor 182 supplied a PWM signal to motor controller 210, which corresponded to a desired motor speed. The PWM signal was a variable duty cycle pulse train that was rectified to a DC level. This signal was supplied to the reference input of controller 210 and compared to the voltage drop across the sensor resistors on controller 210. Controller 210 controlled the current by matching the drop with the reference input, and supplied a constant current PWM signal to the motor 140.

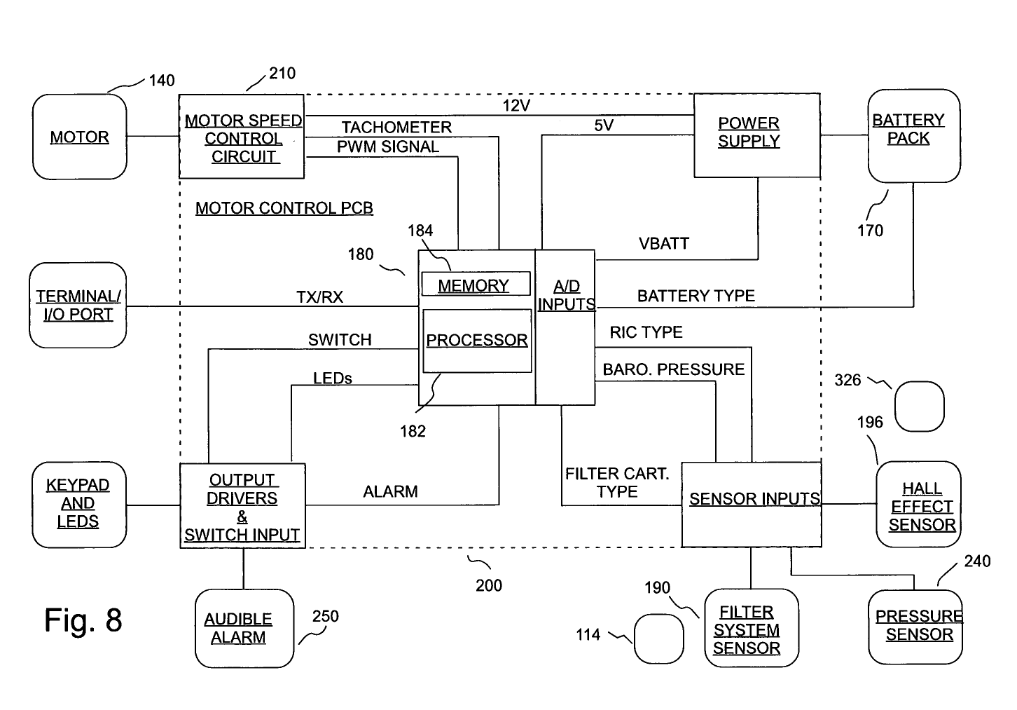

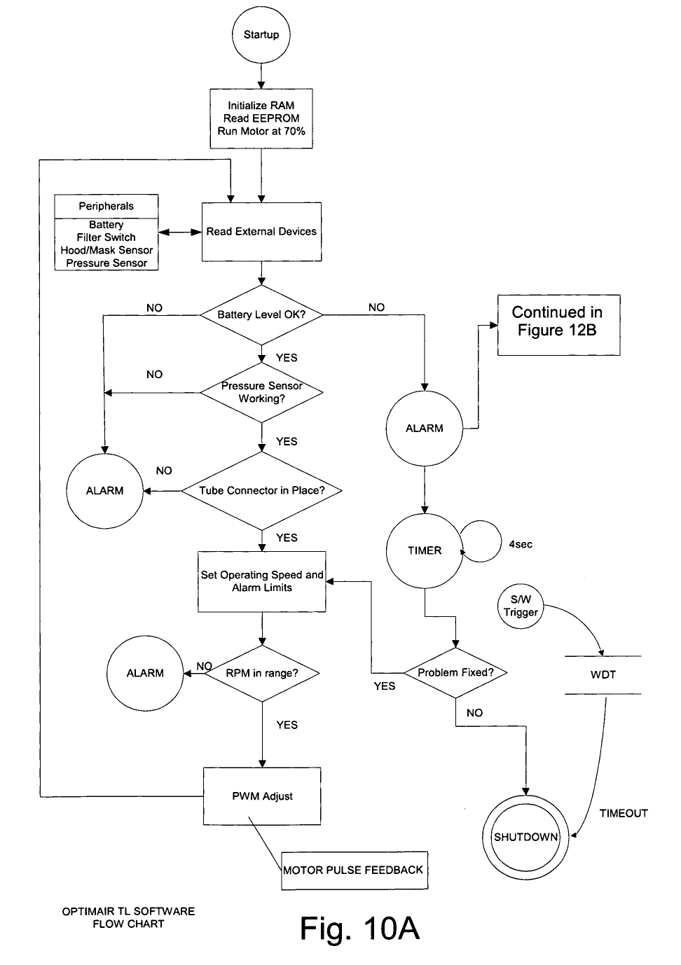

The only manual end-user accessible input on system 10 was an ON/OFF switch 220 (see FIG. 7). Battery pack 170 constantly supplied power to printed circuit board 200. Switch 220 operated as an input to control system 180. Once processor 182 sensed that the user had, for example, pressed switch 220 for at least 1 second, the main routine started. Flow charts for one embodiment of a control algorithm for use in the present invention are illustrated in FIGS. 9 through 10B. To power down system 10 in one embodiment, the user could press and hold switch 220 for at least 3 seconds.

As described above, in several embodiments system 10 provides a steady flow of filtered, breathable air under harsh conditions. Processor 182 determined an operating set point for blower motor 140 as well as upper and lower limits for flow and battery alarms from sensor inputs. The main program loop controls the speed of motor 140, updates battery status display 230, sounds an alarm buzzer 250 and monitors inputs such as from sensor 196, ON/OFF switch 220, a pressure sensor 240 as described further below and filter system sensor 190. An input/output routine provides an interface for a host computer (not shown) connected to the input/output port. This routine provides a mechanism for set up and configuration that (in the illustrated embodiment) is not accessible to the end user.

When the user starts up the unit (by, for example, pressing and holding the power switch for 1 second) the control software determines its set points and configuration. There are several factors which determine the set points, which, in one embodiment, included: facepiece/ or hood/delivery hose configuration; filter system configuration (for example, chemical filter cartridge or particulate filter cartridge); battery pack type (for example, Li-Ion or NiMH) and barometric pressure of ambient air. The software senses each of these conditions at startup and stores this information for the control algorithm.

At startup, motor 140 was set to full speed for one second to quickly overcome the motor inertia. The software then selects a default PWM setting (for example, 70%) and ran motor 140 at this speed. Five seconds after startup (to allow the motor RPM to settle) the software began to monitor the motor RPM. Five seconds later, the first RPM reading was stored and used for the control algorithm. The software receives and processes information from sensor 196 on the output 124 of scroll housing 120 regarding the presence of a respiratory inlet covering (for example, hood 500 or facepiece 600). Once again, in one embodiment, the polarity of magnet 326 as sensed by sensor 196 determined the type of respiratory inlet covering attached to system 10. As also described above, the type of filter cartridge attached to system 10 was determined by a signal from sensor 190 provided to processor 182. In the case of filter cartridges having a higher resistance (for example, chemical filter cartridges have a higher resistance than particulate filter cartridges), the RPM set point was set higher by processor 182.

Pressure sensor 240 (for example, a solid state pressure sensor as know in the pressure sensing arts) detects the ambient air pressure. The density of the ambient air has a direct effect on volumetric flow rate. Because the software uses the motor RPM value as an indication of the flow rate, it is desirable to account for the density of the air. Upon measurement of air pressure, the RPM target value is adjusted accordingly. Pressure sensor 240 produces an analog signal which is transmitted to microprocessor 182, which converts the analog signal to a range of digital readings that corresponds to the air pressure. Table 1 below illustrates one embodiment of the methodology of pressure correction of the present invention. In one embodiment, the pressure sensor 240 (the MPXA4100 integrated pressure sensor available from Motorola of Schaumburg, Ill.) had an output range of 0-4.71 VDC over its full sensor range of 10 to 110 kPa (75-825 mmHg). In one embodiment, the output of sensor 240 was connected to an 8-bit AID input (see FIG. 8) of control system 180. The usable range of sensor 240 was approximately 69.6-103.3 kPa, which represents the air pressures from approximately −500 to 10,000 ft of altitude, including temperature and humidity variations.

TABLE 1

| Reading Pᵣ | Vout | | Pressure | | |
|---|---|---|---|---|---|
| 240 | 4.70 | V | 103 | kPa | 30.42 inHg |
| 150 | 2.79 | V | 68 | kPa | 20.08 inHg |
| | 1.9 | V range | 35 | kPa range | |
| | .02122 | V/step | 0.3889 | kPa/step | |

Conversion for kPa and inHg: P(inHg) = 0.2953 P(kPa)
Conversion for PAPR reading: 0.2953((R − 150) * 0.3889 + 68) =
Atm. Press. (inHg)

| Reading Pᵣ | Pressure (inHg) | (mmHg) | | |
|---|---|---|---|---|
| 150 | 20.08 | 510.04 | 10,000 ft. | |
| 155 | 20.65 | 524.63 | | |
| 160 | 21.23 | 539.21 | | |
| 165 | 21.80 | 553.80 | | |
| 170 | 22.38 | 568.38 | | |
| 175 | 22.95 | 582.97 | | |
| 180 | 23.53 | 597.55 | | |
| 185 | 24.10 | 612.14 | | |
| 190 | 24.67 | 626.72 | | |
| 195 | 25.25 | 641.31 | | |
| 200 | 25.82 | 655.89 | | |
| 205 | 26.40 | 670.48 | | |
| 210 | 26.97 | 685.06 | | |
| 215 | 27.55 | 699.65 | | |
| 220 | 28.12 | 714.23 | | |
| 225 | 28.69 | 728.82 | | |
| 228 | 29.04 | 737.57 | | |
| 230 | 29.27 | 743.40 | | |
| 235 | 29.84 | 757.99 | | |
| 240 | 30.42 | 772.57 | Sea level | |
| 245 | 30.99 | 787.16 | | |
| 250 | 31.56 | 801.74 | −500 ft. | BASE READING |
| 255 | 32.14 | 816.33 | | |

The software uses the pressure reading (Pᵣ) to normalize the RPM setting. The base setting and step change for each reading were empirically derived and tested in an altitude chamber. In one embodiment, the adjusted setting for motor rate for a particular respiratory inlet covering/filter system configuration took the following form: Adjusted Setting=Base+(Full scale reading−Pr)*(Step Change). The adjusted setting equations for the embodiment including four configurations as described above took the following form:

Setting-Hood/Particulate filter cartridge=4885+(250−Pᵣ)*13

Setting-Hood/Chemical filter cartridge=6511+(250−Pᵣ)*16

Setting-Mask/Particulate filter cartridge=5625+(250−Pᵣ)*14

Setting-Mask/Chemical filter cartridge=6860+(250−Pᵣ)*17

The upper and lower alarm limits from motor RPM were also adjusted according to the measured air pressure by a corresponding amount. The upper and lower alarm limits (for example, ±50) thus floated with the RPM set point. In several embodiments, the upper and lower alarm limits change but the span or difference between the limits remained the same. The above methodology assisted in ensuring that the mass flow of air within system 10 was generally the same at any altitude from 500 feet below sea level to, for example, 10,000 ft. Compensation for a wider range of altitudes/ambient pressures can be made with use of a suitable pressure sensor.

Battery voltage also has as effect on the RPM setting. With certain batteries, it may be desirable to adjust the RPM setting if, for example, the voltage dips below a certain level. For example, in the case of one embodiment of an NiMH battery pack 170, the RPM setting was adjusted if the measured voltage was below 13V. The battery voltage was read as an analog value by the processor and converted to a digital reading. The valid range of the battery voltage for NiMH battery pack 170 was approximately 10.0V to 16.0V.

The corresponding reading (Vbatt) at processor 182 was determined as follows: Vbatt=Battery Voltage*9. Table 2 below sets forth RPM setting adjustment according to battery voltage for NiMH battery pack 170. The RPM Adjustment value was subtracted from the final settings shown above for the pressure compensation. This resultant value was the final RPM setting value stored into the memory for the operating point of air delivery system 10. For values of Vbatt readings greater than 120, the RPM adjustment was 0.

TABLE 2

| Vbatt | RPM |
|---|---|
| reading | Adjustment |
| 120 | 0 |
| 119 | 0 |
| 118 | 1 |
| 117 | 1 |
| 116 | 2 |
| 115 | 3 |
| 114 | 4 |
| 113 | 5 |
| 112 | 6 |
| 111 | 7 |
| 110 | 7 |
| 109 | 8 |
| 108 | 9 |
| 107 | 11 |
| 106 | 13 |
| 105 | 18 |
| 104 | 23 |
| 103 | 29 |
| 102 | 37 |
| 101 | 40 |
| 100 | 43 |
| 99 | 46 |
| 98 | 50 |
| 97 | 55 |
| 96 | 60 |
| 95 | 68 |
| 94 | 80 |
| 93 | 93 |
| 92 | 123 |
| 91 | 143 |
| 90 | 175 |
| 89 | 205 |
| 88 | 235 |
| 87 | 263 |
| 86 | 294 |
| 85 | 335 |
| 84 | 375 |

There were several scenarios that would cause an alarm on system 10, including, for example, low battery, high flow, low flow, failure of pressure sensor 240 and failure of hose connector sensor 196.

In several embodiments, a measured remaining battery capacity of under 15 minutes caused actuation of at least one alarm such as an audible alarm 250 (for example, a piezoelectric “buzzer”) during normal operation. As illustrated, for example, in FIG. 6, audible alarm 250 can be positioned to pass sound into scroll housing 120 to ensure that the end user can hear the alarm. Additional or alternative alarms, including, for example, visual and/or tactile alarms can be actuated. Audible alarm 250 could, for example, be sounded at a steady rate (for example, two beeps at a 50% duty cycle over a one second period). At the minimum battery level, PAPR system 10 was shut off to avoid damage to battery pack 170. In several embodiments, audible alarm 250 was a piezoelectric alarm with a constant tone when power was applied thereto.

Once again, audible alarm 250 and/or other alarm(s) can also be sounded/actuated for low or high flow conditions (signaling, for example a restriction or a leak), user activation of the ON/OFF switch, a missing/defective pressure sensor 240 and a missing/defective sensor 196. In several embodiments, the cycle time of alarm 250 was I sec. There can, for example, be different duty cycles for different types of alarms. For example, the duty cycle of alarm 250 can be 500 mS ON and 500 mS OFF (50%) for one type of alarm and can be 200 mS ON, 100 mS OFF, 200 mS ON, 500 mS OFF (a “double beep”) for another type of alarm.

If the flow rate, as determined by measured motor RPM, was above or below the limits for the mode selected, the flow alarm was sounded. Measurements were made about once per second. In several embodiments, an alarm was activated if the flow rate was outside the alarm limits for more than four seconds.

As described above, pressure sensor 240 provided an analog output scaled from 0 to 5 VDC corresponding to the ambient atmospheric air pressure. Once again, one embodiment of pressure sensor 190 had an operating range of approximately 500 feet below sea level to 10,000 feet above sea level. If the reading from sensor 190 indicated a value well outside values corresponding to these altitudes, a sensor fault could be assumed.

An alarm can also be generated if delivery hose 300 was not connected or if it was not fitted properly. In one embodiment, this type of flow alarm was actuated if delivery hose 300 was not detected for a period of time (for example, one second or more), indicating an error in the circuit of sensor 190. The voltage of sensor 190 was scaled. In the case of two possible respiratory inlet covering configurations, for example, only three output values of sensor 190 were important. For example, a value of 128±5 indicated that magnet 326 was not seen. A value of 87 or less indicated a facepiece connector. A value of 162 or greater indicated a hood connector. Any other range of values was an indication that the magnet was present, but not aligned properly with Hall Effect sensor 190.

During a startup phase, if no delivery hose 300 was connected, the software assumed a calibration mode was to be initiated. An alarm was generated, but the software allowed a test fixture or operator to change the operating point.

Because PAPR system 10 is essentially a closed system, the RPM value of motor 140 is inversely proportional to the flow rate. That is, if the flow path is blocked by either a dirty filter or a kinked breathing tube, the back pressure in blower assembly 100 will cause a stall condition on blower impeller 150. Therefore, motor RPM increases as impeller 150 spins in static air. If, on the other hand, the resistance to flow is decreased by a loose or missing filter cartridge 114, connector hose 300 being removed from the respiratory inlet covering or the respiratory inlet covering being removed from the wearer's head, there is a greater load on the impeller blades since air is continually flowing over their surface. The motor RPM will therefore decrease.

If after a certain period of time (for example, thirty seconds), the target RPM value of motor 140 is not within the limits calculated at calibration, a flow alarm can be generated. The alarm can be reset if the RPM returns to normal range. In several embodiments, the provided alarm was both audible (via audible alarm 250) and visual via LED's 230 (battery LED) and 234 (flow alarm LED). During the startup phase, if the RPM value was grossly outside the limits (for example, ±500 to 1000 RPM), an alarm was also generated. In that case, a catastrophic failure event was assumed. In such a case, the motor can be shutdown to avoid damage to the drive mechanism as well as to the motor itself, due to a stall condition.

If no alarms were detected after a certain period of time (for example, three minutes) after startup, the software saved the current PWM and alarm settings.

To place the unit in an operating mode, the user is required to connect hose 300 and filter cartridges 114 and to start or restart system 10. At startup, the software calculated the set point as described above and entered a motor control loop. The motor is allowed to stabilize for a period of time (for example, approximately one minute).

After the motor stabilization period, the software compared the measured RPM reading to the set point target value. If adjustment was needed, the PWM was incremented or decremented. This process was repeated after the second, third and forth minute of operation. The software stored the final PWM value into memory. If, for example, the actual RPM value rose above the set point value plus the alarm band (for example, +50) as described above, a flow alarm was generated.

In this manner, system 10 calibrated the motor speed to the actual flow resistance of the closed system each time motor 140 was started. At this point, the speed of motor 140 was set by motor controller 210. To preserve battery capacity, the PWM value was not increased after this “settling in” period.

As discussed above, one or more types of alarms can be actuated in an alarm condition. For example, LEDs 230 and 234 (which can be of difference colors—such as red and green—and different patterns) on the front panel of blower assembly housing 110 can be actuated. In several embodiments, LEDs 230 and 234 were always used in concert with audible alarm 250. LEDs 230 provide an indication of battery voltage alarm, while LEDs 234 provide an indication of flow alarm. There were also several LEDs on membrane switch 220, which, upon power up, were all activated by the systems software for one second. Audible alarm 250 was also sounded twice upon power up.

For example, a bank of green LEDs 230 can be arrayed as a ‘fuel gauge’ to inform the user of battery status. Three green LEDs can, for example, signal that battery is at or near full charge. As the output voltage of the battery pack decreases, this can, for example, be reflected by a decrease in the number of LED's illuminated. If the voltage falls below a preset level, a red LED can, for example, be illuminated. As described above, this condition will generate an audible alarm and is a signal to the user that he has 15 minutes to leave the hazardous area before system 10 shuts off to protect battery pack 170.

The input/output port can, for example, be used as a debugging and calibration tool. The port can, for example, be made inaccessible to the end user. A parser function can, for example, poll data input via port 204 and provides a periodic update on the condition of system 10. Alarms can also be reported via the input/output port.

During factory set up of the unit, it is possible to calibrate motor 140 for a set flow rate so that the startup filter calibration is normalized for each system 10. The input/output port allows the manufacturer to set the PWM value for each motor 170 to achieve this flow rate. During “normalization” as described above, each blower assembly was adjusted to provide the same motor RPM (that is, flow) at the same input reference voltage. The resultant PWM control setpoint for each unit was stored in flash memory as the ‘setpoint’. As a result of the normalization, if each blower assembly unit were connected to filters cartridges 114 and/or delivery hoses 300/RIC that provided the same overall flow resistance, each blower assembly would provide equal flow even if the PWM setpoint of one blower assembly was different from another. The normalization process compensates for the differences in each motor and/or in each motor control system.

The manufacturer may also use the input/output port to, for example, “burn-in” a unique serial number for each system 10, reset the operating hours counter, read the serial number and operating hours, start and stop motor 170 and read the version number of the software stored in memory 184. The input/output port function can, for example, be UART-compatible and can interface to generally any terminal emulator program.

The foregoing description and accompanying drawings set forth the preferred embodiments of the invention at the present time. Various modifications, additions and alternative designs will, of course, become apparent to those skilled in the art in light of the foregoing teachings without departing from the scope of the invention. The scope of the invention is indicated by the following claims rather than by the foregoing description. All changes and variations that fall within the meaning and range of equivalency of the claims are to be embraced within their scope.

What is claimed is:

1. A powered air purifying respirator system for use with at least one filter system, comprising:
a housing comprising at least one inlet port and at least one outlet port;
a motorized air flow system to draw air into the housing via the at least one inlet port;
a control system in communicative connection with the motorized air flow system; and
a filter system sensor in communicative connection with the control system to provide information to the control system relating to the type of the at least one filter system upon fluid connection thereof with the housing.

2. The powered air purifying respirator system of claim 1 wherein the control system controls the motorized air flow system at least in part on the basis of the type of filter system sensed by the filter system sensor.

3. The powered air purifying respirator system of claim 2 wherein the filter system comprises a filter cartridge which comprises at least one filtering medium positioned within a filter cartridge housing.

4. The powered air purifying respirator system of claim 2 further comprising a pressure sensor to measure ambient pressure.

5. The powered air purifying respirator system of claim 1 wherein the control system controls the motorized air flow system at least in part on the basis of information relating to ambient pressure.

6. The powered air purifying respirator system of claim 2 further comprising at least one configuration sensor to sense the type of respiratory inlet covering in fluid connection with a delivery hose upon fluid connection of the delivery hose with the outlet port.

7. The powered air purifying respirator system of claim 5 further comprising a at least one configuration sensor to sense at least one of the type of respiratory inlet covering in fluid connection with a delivery hose upon fluid connection of the delivery hose with the outlet port.

8. The powered air purifying respirator system of claim 2 wherein the control system determines a set point for the rate of rotation of a motor of the motorized air flow system.

9. The powered air purifying respirator system of claim 7 wherein the control system determines a set point for the rate of rotation of a motor of the motorized air flow system.

10. The powered air purifying respirator system of claim 9 further comprising a system to measure battery voltage.

11. The powered air purifying respirator system of claim 10 wherein the control system determines the set point at least in part on the basis of the measured battery voltage.

12. The powered air purifying respirator system of claim 9 wherein limits above and below the set point are established and an alarm system is actuated if the motor rate is outside one of the limits for a determined period of time.

13. The powered air purifying respirator system of claim 12 wherein the limits are adjusted by the same amount as the set point as a result of at least one of the following: the type of filter system, the measured ambient pressure or the type of respiratory inlet covering.

14. The powered air purifying respirator system of claim 13 further comprising the at least one filter system.

15. A powered air purifying respirator system for use with at least one filter system, comprising:
a housing comprising at least one inlet port and at least one outlet port;
a motorized air flow system to draw air into the housing via the at least one inlet port;
a control system in communicative connection with the motorized air flow system; and
a pressure sensor in communicative connection with the control system to provide information to the control system relating to ambient pressure.

16. The powered air purifying respirator system of claim 15 wherein the control system controls the motorized air flow system at least in part on the basis of the information relating to ambient pressure.

17. A method of operating a powered air purifying respirator system, comprising: sensing a filter system placed in operative connection with the powered air purifying system and controlling the powered air purifying respirator system at least in part on the basis of information relating to the filter system.

18. The method of claim 17 further comprising determining a set point for the rate of rotation of a motor of the motorized air flow system at least in part on the basis of the information relating to the filter system.

19. The method of claim 18 further comprising determining limits above and below the set point and activating an alarm system if the rate of rotation of the motor is outside one of the limits for a determined period of time.

20. The method of claim 17 further comprising measuring ambient pressure and controlling the powered air purifying respirator system at least in part on the basis of information relating to ambient pressure.
